(19) United States
(12) Patent Application Publication
(10) Pub. No.: US 2009/0011827 A1
(43) Pub. Date: Jan. 8, 2009

(54) Wagering Game With Tournament-Play Features

(75) Inventors: Allon G. Englman, Chicago, IL (US); Mark B. Gagner, West Chicago, IL (US); Benjamin T. Gomez, Chicago, IL (US); Walter E. Smolucha, Melrose Park, IL (US)

Correspondence Address: NIXON PEABODY LLP, 161 N CLARK ST., 48TH FLOOR, CHICAGO, IL, 60601-3213, US

(73) Assignee: WMS Gaming Inc, Waukegan, IL (US)

(21) Appl. No.: 12/161,849

(22) PCT Filed: Jan. 23, 2007
(86) PCT No.: PCT/US07/01757

§ 371 Date: Jul. 23, 2008

(30) Foreign Application Priority Data
Jan. 23, 2006 (US) 60761647

(51) Int. Cl. A63F 9/24; A63F 13/00

(52) U.S. Cl. 463/27

(57) ABSTRACT

A method is presented for offering a wagering game tournament to a plurality of players on a plurality of gaming machines, which are located on a gaming network. The method includes increasing a prize pool based on a group achievement of the plurality of players, and distributing the prize pool to at least some of the plurality of players.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines and, more particularly, to a gaming system including at least one tournament feature for stimulating competition and collaboration among players.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games, which will attract frequent play by increasing the entertainment value and excitement for the player.

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game and progressive award concepts offers tremendous advantages in player appeal and excitement relative to other known games, and because such games are attractive to both players and operators, there is a continuing need to develop gaming machines with new types of bonus games to satisfy the demands of players and operators.

While these player appeal features provide some enhanced excitement relative to other known games, there is a continuing need to develop new features for gaming machines to satisfy the demands of players and operators. Specifically, some of the current games provide enhanced excitement solely to a successful player playing on one gaming machine of a bank of gaming machines. Thus, there is a need for sharing the enhanced excitement of the successful player with other players playing on the bank of gaming machines.

### SUMMARY OF THE INVENTION

According to one aspect of the present invention, a method is presented for offering a wagering game tournament to a plurality of players on a plurality of gaming machines, which are located on a gaming network. The method includes increasing a prize pool based on a group achievement of the plurality of players, and distributing the prize pool to at least some of the plurality of players.

According to yet another aspect of the invention, a gaming network offers a wagering game tournament to a plurality of players on a plurality of gaming machines. Each gaming machine includes a display and a controller. The display displays the wagering game tournament in response to receiving a wager input from a player. The controller is coupled to the display and is programmed to allow a player of the plurality of players to participate in the wagering game tournament. The controller is further programmed to increase a prize pool based on a group achievement of the plurality of players, and to distribute the prize pool to at least some of the plurality of players.

According to yet another aspect of the invention, a method of conducting a wagering tournament on a gaming network includes accepting a group of players for participation in the wagering tournament. Each player of the group of players plays on a corresponding gaming machine of the gaming network. The method further includes achieving a group-based tournament threshold, increasing a tournament prize based on the achieving step, and distributing the tournament prize to the group of players.

According to yet another aspect of the invention, a computer readable storage medium or media is encoded with instructions for directing a gaming device to perform the above methods.

According to yet another aspect of the invention, a method is directed to offering a wagering game tournament to a plurality of players on a plurality of gaming machines located on a gaming network. The method includes representing graphically in real-time a tournament rank for each of the plurality of players.

According to yet another aspect of the invention, a method is directed to offering a wagering game tournament to a plurality of players on a plurality of gaming machines located on a gaming network. The method includes receiving one or more game selections from each of the plurality of players and achieving a corresponding randomly generated result for each of the plurality of players based on the received game selections. The method further includes awarding an award to a player of the plurality of players whose corresponding randomly generated result meets a tournament winning criterion.

According to yet another aspect of the invention, a method is directed to offering a wagering game tournament to a plurality of players on a plurality of gaming machines located on a gaming network. The method includes selecting a first game from a multi-game menu by a first player of the plurality of players and selecting a second game from the multi-game menu by a second player of the plurality of players. The method further includes determining a tournament winner based on a common criterion for both the first game and the second game.

According to yet another aspect of the invention, a method is directed to offering a wagering game tournament to a plurality of players on a plurality of gaming machines located on a gaming network. The method includes varying game play from an initial game-play configuration to a next game-play configuration based on a tournament parameter; and awarding a tournament prize to a tournament winner.

According to yet another aspect of the invention, a method is directed to offering a wagering game tournament to a plurality of players on a plurality of gaming machines located on a gaming network. The method includes starting head-to-head tournament play with each of the plurality of players being placed in a first tournament bracket, moving each losing player from the first tournament bracket to a second tournament bracket, and playing head-to-head games in the second tournament bracket. The method further includes eliminating each losing player that from the second tournament bracket and awarding a first award to a winning player of the first tournament bracket and a second award to a winning player of the second tournament bracket.

According to yet another aspect of the invention, a method is directed to offering a wagering game tournament to a plurality of players on a plurality of gaming machines located on a gaming network. The method includes increasing a prize pool based on at least one of the plurality of players achieving a tournament milestone.

According to yet another aspect of the invention, a method is directed to offering a wagering game tournament to a plurality of players on a plurality of gaming machines located on a gaming network. The method includes receiving a side wager from a first player of the plurality of players for wagering on a second player of the plurality of players and awarding an award to the first player if the second player is a tournament winner.

According to yet another aspect of the invention, a method is directed to offering a wagering game tournament to a plurality of players on a plurality of gaming machines located on a gaming network. The method includes providing a communal pot to a first player of the plurality of players, risking any portion of the communal pot that is not banked by the first player, and determining a randomly generated outcome based at least in part on game-related input received from the first player. The method further includes awarding an award if the next outcome is a winning outcome, the award being determined based in part on the value of the communal pot, adjusting the value of the communal pot based on the award, and carrying forward the adjusted communal pot to a second player of the plurality of players.

According to yet another aspect of the invention, a method is directed to offering a wagering game tournament to a plurality of players on a plurality of gaming machines located on a gaming network. The method includes selecting a game block from one or more of previously played wagering sessions to enter as a tournament entry block.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The foregoing and other advantages of the invention will become apparent upon reading the following detailed description and upon reference to the drawings in which:

FIG. 1 is a perspective view of a gaming machine embodying the present invention;

FIG. 2 is a block diagram of a control system suitable for operating the gaming machine of FIG. 1;

FIG. 3 is a chart representing a variable prize pool tournament, according to one embodiment of the present invention;

FIG. 4 is a flowchart representing a collaborative tournament, according to another embodiment of the present invention;

FIG. 5 is a graphical representation of a tournament status on a secondary display, according to an alternative embodiment of the present invention;

FIG. 6 is a flowchart representing a side wagering tournament, according to another alternative embodiment of the present invention;

FIG. 7 is a body diagram representing a passive participation tournament, according to yet another alternative embodiment of the present invention;

FIG. 8 is a flowchart representing a risk and reward tournament, according to yet another alternative embodiment of the present invention;

FIG. 9 is a flowchart representing a multi-game tournament, according to yet another alternative embodiment of the present invention;

FIG. 10 is a body diagram representing an elimination tournament, according to yet another alternative embodiment of the present invention;

FIG. 11 is a body diagram representing an automated/manual variable game-play tournament, according to yet another alternative embodiment of the present invention; and

FIG. 12 is a body diagram representing a retroactive tournament, according to yet another alternative embodiment of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

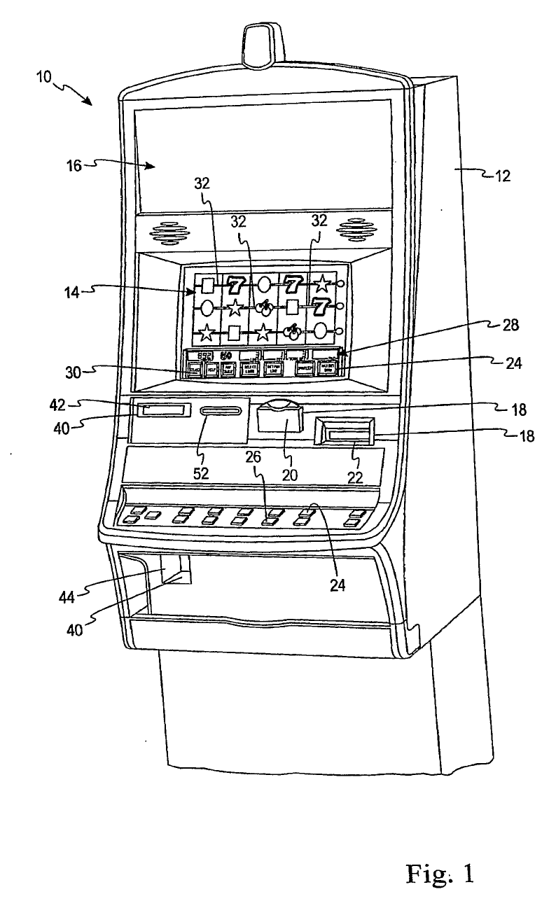

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

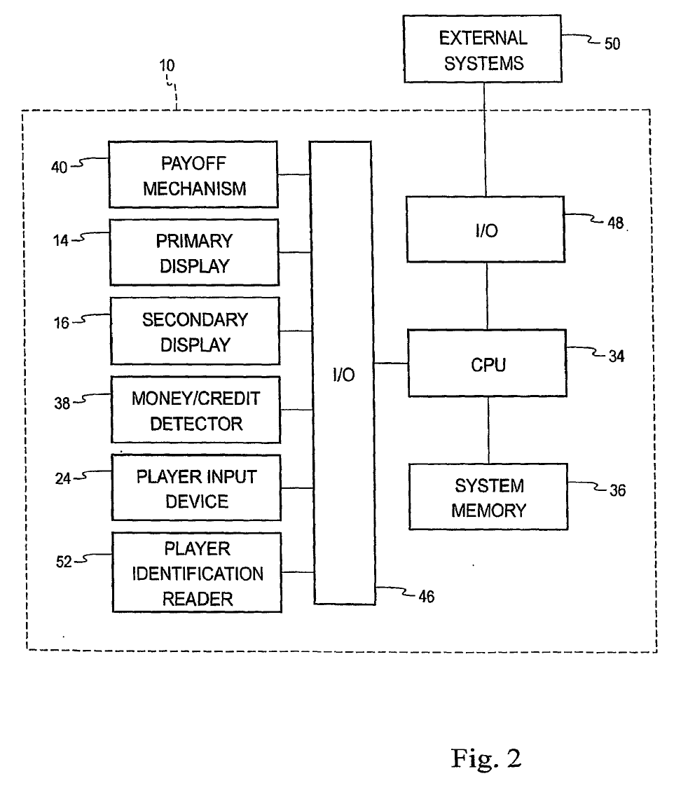

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

### Variable Prize Pool

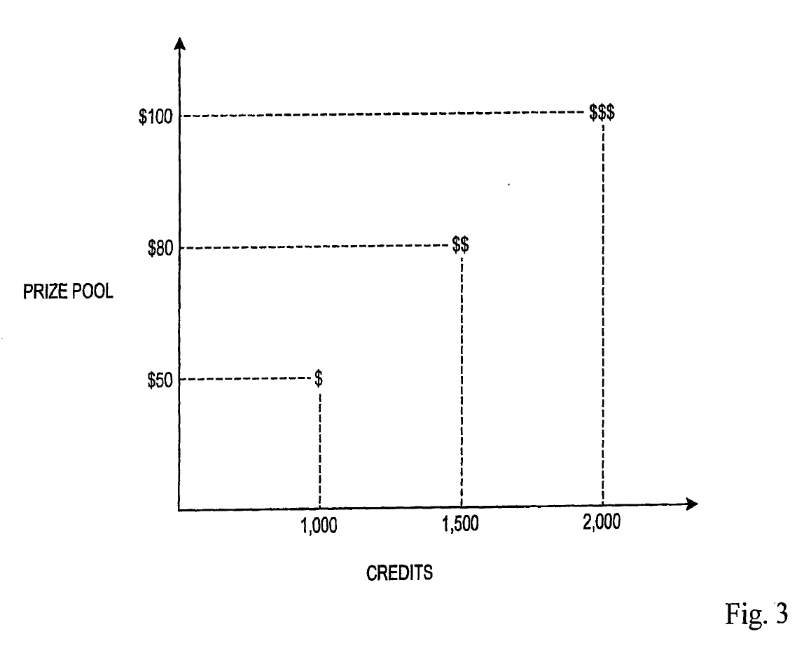

Referring to FIG. 3, a chart shows a representation of a variable prize pool that changes during tournament play. For example, the prize pool may increase or decrease as a result of meeting a predetermined condition. After a plurality of players have entered a tournament and tournament play begins, the variable prize pool for the tournament increases for each milestone, or threshold, achieved.

The variable prize pool may be change based on one or more of a group of variables, including a random number, a random result, or a conglomeration of random results. The variables can include time, individual thresholds, symbol-driven outcomes, particular scores, etc. Thus, when a threshold is achieved for a particular variable, the prize pool changes.

For example, each player may start playing in the tournament with 1,000 credits. The prize pool is $50 at the start of the tournament. When a player achieves 1,500 credits, the prize pool increases to $80. Further, if a player achieves 2,000 credits, the prize pool increases to $100. Thus, instead of having a static prize pool, the prize pool dynamically changes whenever a predetermined threshold is achieved.

In another example, the prize pool changes based on time. When a fixed period of time elapses, the prize pool increases to a next amount. Optionally, the prize pool changes based on a player achieving a particular score. The particular score can be based on the lowest number of spins or on the first person to reach a particular score. For example, the prize pool increases if a player reaches a particular score within a specific number of spins. Alternatively, the prize pool decreases if none of the players reaches the particular score with the specific number of spins. In a further example, it is assumed that a tournament is a one-hundred-spin tournament. If any player reaches a score of 1,000 points within the first 10 spins, the prize pool increases from a starting amount of $50 to a next value of $100. If none of the players reaches the score of 1,000 points within the first 10 spins, the prize pool decreases to an amount of $45.

In yet another example, the prize pool increases based on achieved symbols. If a certain symbol or a certain number of symbols are achieved, based on outcomes for one or more of the tournament players, the prize pool increases.

Optionally, the prize pool may be increased to a predetermined amount. For example, the prize pool may deliberately start with a low amount and, during the course of the tournament, increase to an average amount of a prize pool. Thus, while the increase in the prize pool provides an appearance of a higher prize pool to the player, the gaming establishment may in actuality provide the same prize pool that would otherwise be provided if the prize pool would be a constant amount.

The prize pool may change based on the number of players playing in the tournament. For example, the prize pool may increase as the number of players decreases. Thus, if a player is eliminated or quits the tournament, the prize pool automatically increases to a next amount. Alternatively, if the tournament permits players to join as the tournament is being played, the prize pool may increase as the number of players increases. The more players joining the tournament, the higher the prize pool because it is being funded by a larger group of players.

The change in the prize pool may be used as a tournament terminating outcome. For example, the tournament ends if the prize pool reaches a predetermined amount. If the prize pool reaches zero, for example, the tournament is over. Similarly, for example, the tournament is over if the prize pool reaches a maximum prize pool.

### Collaboration to Build and Distribute a Prize Pool

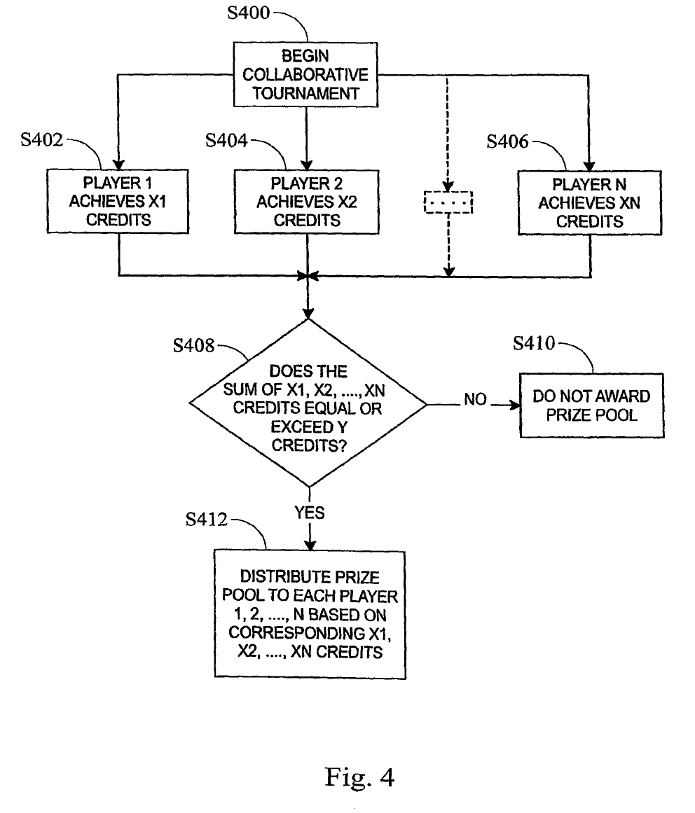

Referring to FIG. 4, a flow chart represents a collaborative tournament for building and distributing a prize pool. In general, a group of players plays together in a tournament against the house to share the house prize. As a group, the players are required to receive a high score, for example, to determine the prize pool. Thus, the better the players do as a group, the higher the prize pool. For example, the prize pool starts at a low amount and increases as much as feasible (so that the gaming establishment still makes a profit).

At step S400, the group of players enter and begin play in the collaborative tournament. At steps S402-S406, Players 1-N achieve X1-XN credits. At step S408, a determination is made whether the sum of X1, X2, . . . , XN credits equals or exceeds a threshold requirement of Y credits. At step S410, if the sum of X1, X2, . . . , XN credits does not equal or exceed Y credits, the prize pool is not awarded.

At step S412, if the sum of X1, X2, . . . , XN credits equals or exceed Y credits, the prize pool is distributed to Players I-N based on the corresponding credits of each player. For example, each player receives a percentage of the prize pool based on the percentage of credits that the player contributed to achieving the required Y credits threshold.

The collaborative tournament can be designed to encourage increased play-pace. For example, the tournament is a one-hundred-spin tournament in which the more you spin the more likely it is that the group will win the prize pool. If the tournament has a time limit, the players are discouraged from sitting back and risking losing available spins that may contribute to the group achieving a predetermined total number of credits.

The group of players can work together toward a tournament terminating outcome. Upon achieving a predetermined outcome, as a group, the tournament ends and the prize pool is distributed to the players. For example, a tournament terminating outcome is an achievement of a group total of 1,000 points. When the tournament is over, the prize pool is distributed to the players. The tournament continues until the 1,000 points are achieved. Thus, each player is rooting that all the other players in the tournament achieve as many points as possible.

In another example, a group of ten players play against the house for a $5,000 prize pool. If the group achieves a set outcome, the prize pool of $5,000 is distributed among the group of players. Optionally, the prize pool may vary based on variables such as the number of accumulated credits. For example, if all the players accumulate 1,000 credits, the prize pool is $100. If the players continue accumulating credits and reach 10,000 credits, the prize pool increases to $1,000. At the end of the tournament, the prize pool is distributed based on player ranking. For example, a player that achieves half of the 10,000 credits (i.e., 5,000 credits) will receive half of the $1,000 prize pool (i.e., $500). Similarly, a player that achieves twenty percent of the total credits (i.e., 2,000 credits) will receive twenty percent of the prize pool (i.e., $200). Accordingly, if a player hits a triple-seven slot combination that wins 1,000 credits, the other players will be happy because the 1,000 credits contributes to the total amount required for obtaining a larger prize pool.

For funding the prize pool, the players may buy-in an entry spot in the tournament for a predetermined fee. Part of the entry fee funds the prize pool and part of the fee is used for the costs associated with running the tournament, such as software, profit, equipment, etc. The part of the fee that is used by the gaming establishment is, in general, under about ten percent of the entry fee. For example, an entry fee may be $20, wherein $18 is used for the prize pool and $2 is used for tournament-associated costs.

Optionally, the prize pool is distributed uniformly among the players. Thus, regardless of the individual contribution of each player, each player will receive an equal portion of the prize pool. Alternatively, only a select number of players receive portions of the prize pool. For example, to discourage a player from simply relying on the rest of the players to achieve the required number of credits, the prize pool may be distributed among all the players except the player with the worst ranking. Alternatively yet, the prize pool is distributed randomly with or without further player input.

Other variables, besides credits, may be used to achieve the necessary threshold for winning the tournament. Any of the thresholds described in reference to FIG. 3 may be used in a collaborative tournament. For example, the prize pool is won by the group of players if all the players achieve a predetermined symbol combination within a predetermined number of spins. Thus, if all the players achieve a triple-seven combination within ten spins, the prize pool is won and distributed uniformly among the players.

### Graphical Representation of Tournament Status

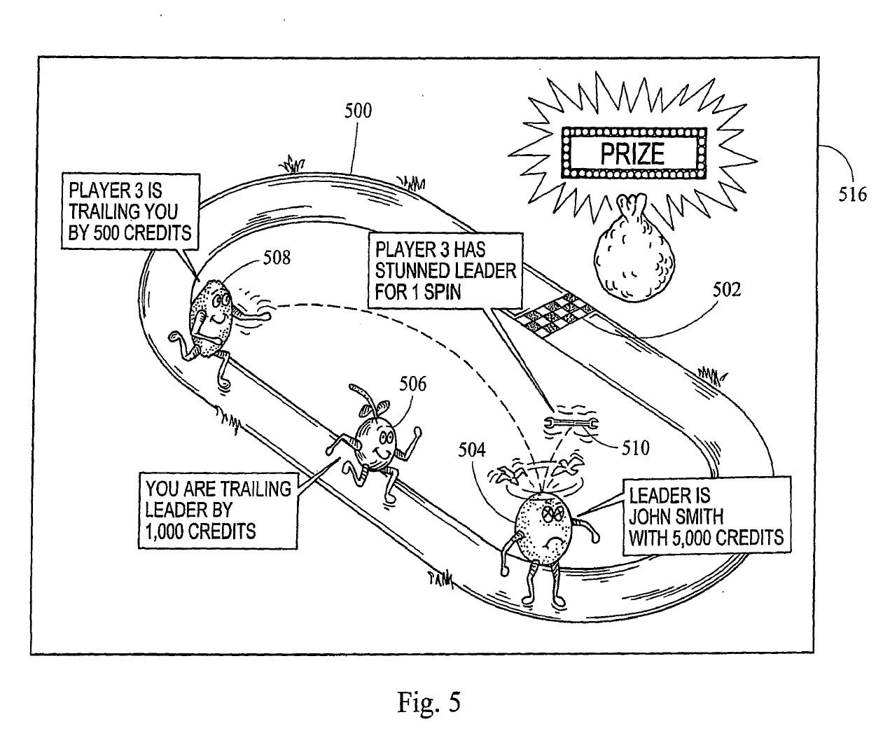

Referring to FIG. 5, tournament status is represented in graphical form to show the rank of each player in real time. Various indicators may be used to indicate the rank of a current player relative to other tournament players. The indicators include race-track indicators (which are similar to horse race-tracks), bar indicators (which are similar to bar charts), map indicators, etc. The tournament status may be indicated on player primary displays, secondary displays, signage, etc.

Various indicators are shown along a race-track 500, including a prize indicator 502, a leader indicator 504, a current-player indicator 506, a trailing-player indicator 508, and a wrench indicator 510. The race-track 500, along with the indicators 502-510, are displayed on a secondary display 516.

The prize indicator 502 represents visually how far each player is from achieving a winning outcome, such as a prize pool. Various informational pop-outs are optionally used to clarify or indicate tournament-related information. For example, the leader indicator 504 indicates the relative position of a current Leader and a pop-out indicates that the name of the Leader is “John Smith” and that he has achieved 5,000 credits.

The current-player indicator 506 and its associated pop-out informs the current player that he or she is trailing by 1,000 credits. Thus, the current player is aware in a quick and simple manner that 1,000 credits are necessary to tie the Leader and also that the Leader is relatively close to winning the tournament. The trailing-player indicator 508 shows that the trailing player is trailing the current player by 500 credits.

Optionally, each player may be provided with one or more options during the tournament that, upon being exercised, can affect the advancement of another player. For example, using a forced-losing spin feature, each player is provided with a single monkey wrench per tournament, which, when thrown, “freezes” a higher-ranked player such that the higher-ranked player is forced to forfeit a turn (e.g. a spin). As shown, the wrench indicator 510 has been thrown by Player 3 to stun the Leader for one spin. Thus, the current player and Player 3 have a one-spin advantage to advance towards the Leader.

Using the forced-losing spin feature may require some strategy on the part of each player. For example, if the Leader has won six spins in a row and a seventh winning spin will double the Leader's award, a trailing player will hit the Leader with the monkey wrench to cause the Leader to at least temporarily fail to double the award.

Optionally, the forced-losing spin, such as the monkey-wrench, may only be used on a player that is ranked immediately ahead of the player. The forced-losing spins may be awarded at the beginning of the tournament or may be accumulated as bonus features throughout the tournament. The forced-losing spins that are available for each player may be revealed next to each player or may be kept unrevealed. If the forced-losing spins are revealed, a strategy element is involved at least because the players will use the available forced-losing spins cautiously. For example, a first player may not want to upset a second player by throwing a monkey wrench at the second player. In return, the first player is hopeful that the second player will return the favor and will not use his or her monkey wrench against the first player.

In an alternative representation, the tournament players are each indicated on a map of United States. The representation depicts a tour across United States, wherein whoever arrives first in Seattle wins the tournament. Thus, Seattle represents a set credit amount that is required for winning a prize pool. The more credits that a player has achieved, the closer that player is to reaching Seattle. The players can be represented with little cars that can advance towards the finish line, i.e., Seattle, or go backwards. For visual purposes, a current player may not be concerned with the location of the finish line, but may be concerned with whether the rest of the players are ahead or behind the current player on the map.

Optionally, in addition to showing the position of the current player relative to other players in the tournament, the graphical representation may also depict a view of what is immediately in front of the current player. For example, the graphical representation may include a view of the closest leading player taunting the current player.

### Side Wagering

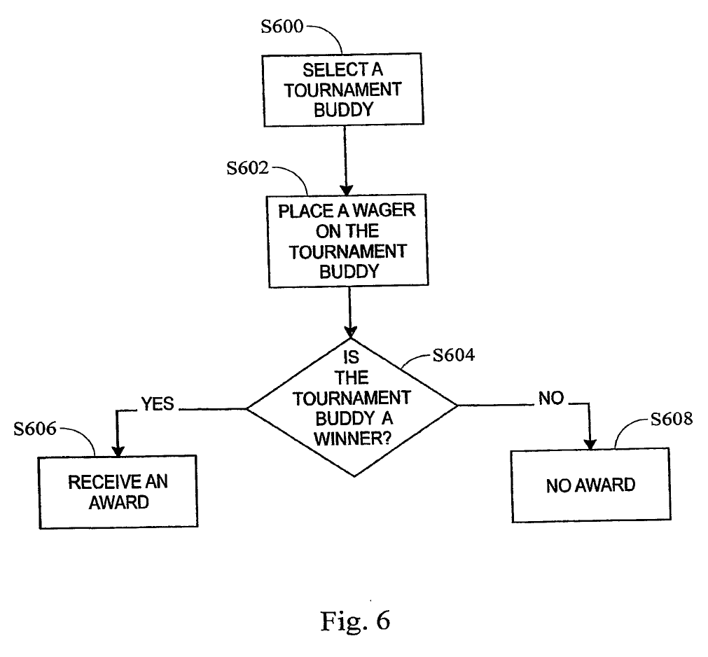

Referring to FIG. 6, a flowchart represents a tournament in which a player (the current player) places a wager on a tournament buddy. The tournament buddy can be one or more players currently playing in the tournament. At step S600, the player selects at least one tournament buddy. At step S602, the player places a wager (also referred to as a side wager) on the tournament buddy. At step S604, a determination is made whether the tournament buddy is a winner. If the tournament buddy is a winner, at step S606 the player receives an award. If the tournament buddy is not a winner, at step S608 the player does not receive an award.

An advantage of wagering on the tournament buddy is that it increases the winning opportunities of the player during the tournament. Specifically, the player is provided with the opportunity to diversify his or her credit amount. Thus, even if the player does not win the tournament, the side wager may provide the player with a winning outcome if the tournament buddy wins the tournament.

The player may select the tournament buddy from a list including every player playing in the tournament. Alternatively, the list may be restricted based on particular characteristics of the tournament players, such as geographical location. For example, the tournament buddy may be selected from a list of players that are located in a specific continent, in a specific country, or in a specific gaming establishment. The list of players may, optionally, present player information to help in the tournament buddy selection. For example, the list may include biographical information, winning history, etc. Thus, if the player has a good feeling about an old lady from Vienna, Austria, the player selects the old lady as the tournament buddy. Then, even if the player does not win the tournament, the player may win a prize if the old lady is successful in winning the tournament.

The player receives an award that is based on the percentage of the prize won by the tournament buddy. For example, if the tournament buddy wins a prize of $1,000, the player receives an award that is ten percent of the prize, i.e., $100. Alternatively, the player receives an award that is a fixed award. For example, regardless of the amount awarded to the tournament buddy, the player receives a $50 award.

The award awarded to the player is funded by a buddy-wager pool. A portion of the side wagers is allocated to the buddy-wager pool. If the tournament buddy is a winner, the entire buddy-wager pool, or, optionally, a portion of the buddy-wager pool, is awarded to the player that has side wagered on the winning tournament buddy. Optionally, the buddy-wager pool may be distributed to more than one player. For example, the buddy-wager pool is distributed to three players that have side wagered on the top three ranked players of the tournament.

Optionally, the player can side wager on more than one tournament buddy. The player can wager the same amount on a plurality of tournament buddies, or can wager different amounts on each of the tournament buddies. For example, the player can wager a large amount on a first tournament buddy that, in the player's opinion, is most likely to win the tournament, and a small amount on a second tournament buddy that, in the player's opinion, is next most likely to win the tournament.

In an alternative embodiment, the tournament buddy does not need to approve the side wagers. Thus, the side wagers are independent of the tournament buddy and are automatically confirmed. Alternatively, the tournament buddy must approve the side wagers. For example, after side wagers have been made on the tournament buddy, the tournament buddy must approve or reject the side wagers. Thus, the side wagers are not automatically confirmed.

The player does not necessarily have to enter the same tournament in which the tournament buddy is playing. For example, the player can access a tournament that shows a tournament that is about to start. The player reviews information related to the tournament players, such as the winning history of each player. After the player selects a tournament buddy/buddies, the player waits for the tournament results. If the tournament extends over a long period of time, e.g., a few hours, the player may periodically check to see the results. The player may get excited when the tournament buddy seems to be winning or less excited when the tournament buddy seems to be losing. If the tournament is a volatile tournament, the tournament buddy can drastically change rankings in the middle of the tournament. For example, if the tournament buddy has been losing the first half of the tournament, the tournament buddy may have a good streak and lead the tournament in the second half of the tournament. The player is most likely to get very excited when the tournament buddy changes from a losing position to a leading position.

The side wagers can be made at any location that provides access to a gaming machine. For example, the side wagers can be made in a gaming establishment, at home, or on any online computer. The players can use a website to access information regarding any current tournaments being played and place side wagers on players of those tournaments. In a further example, the players can use wireless communicators, such as cellular phones, to place the side wagers.

Optionally, tournaments of games having different volatility and/or odds can have corresponding handicaps. For example, if side wagers may be received for a first game, which has a high volatility, and a second game, which has a low volatility, handicaps may be associated with each of the first game and the second game such that the resulting volatility is generally equal. A handicap may be applied to the first game such that the volatility of the first game is lowered to be about the same as the second game. Alternatively, a handicap may be applied to the second game such that the volatility of the second game is raised to be about the same as the first game. Alternatively yet, a first handicap is applied to the first game and a second handicap is applied to the second game such that each volatility is changed to be about the average value of the two volatilities.

### Passive Participation

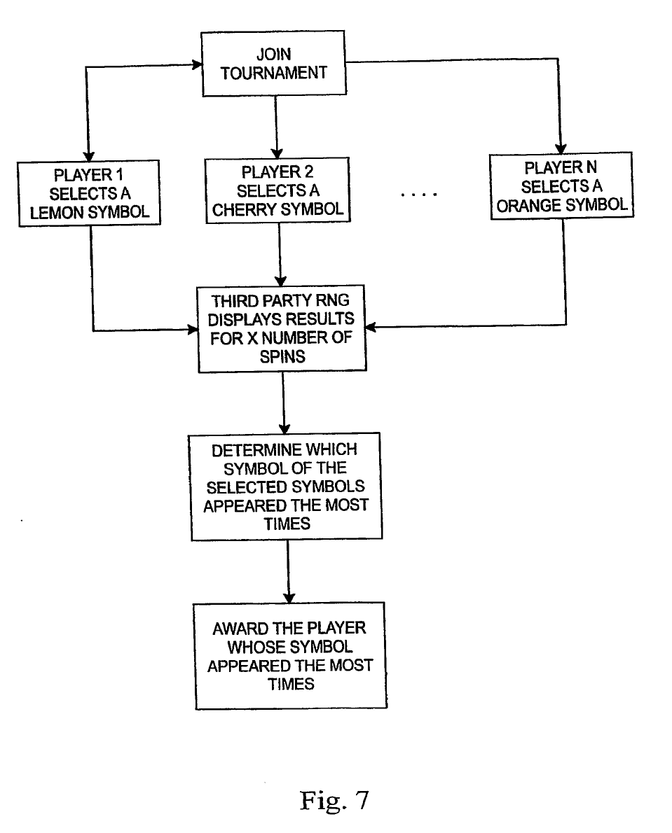

Referring to FIG. 7, a passive participation tournament is provided in which players make one or more selections and then sit back and observe the results. Thus, after the initial selections, the player participation in the tournament is passive—they watch the randomly selected results, hoping that their initial selections will result in an award.

A plurality of players join a tournament at step S700. The players join the tournament by buying-in the tournament, e.g., paying a tournament entry fee, using previously awarded credits, etc. Player 1 selects a lemon symbol at step S702, Player 2 selects a cherry symbol at step S704, and Player N selects an orange symbol at step S706. At step S708, a third party random number generator (“RNG”) displays the results for an X number of slot spins. At step S710, a determination is made regarding which symbol of the lemon symbol, the cherry symbol, and the orange symbol, appeared the most during the slot spins. At step S712, the player whose symbol appeared the most times receives an award. Other examples of passive tournaments include tournaments in which the player buys/sells stocks, places oil wells around the world, plays a Monopoly® game, wagers on race horses, etc. The players pay a buy-in tournament entry fee, which provides the players with one or more selections. In a tournament related to buying and/or selling of stocks, the players buy one or more stocks (i.e., selects the stocks) and then the RNG determines which stocks have made the most profit. In a tournament related to oil wells, the players initially select one or more oil well locations and then the RNG determines which oil well location has drilled the most oil. In a tournament related to the Monopoly® game, the players select one or more property locations. After all the players have made their property selections, a random Monopoly® game is played without any additional input from the players. Each property owner is hopeful that other players “land” on their properties. A player “landing” on an owned property pays the owner a tax. The player with the most accumulated tax money wins a prize at the end of the tournament. In a tournament related to race horses, the players select one or more horses. The player or players that have selected the winning horse are awarded a prize.

In an alternative embodiment, the players initially order a paytable. After each player has ordered a paytable, the RNG provides randomly selected outcomes. The player with the most earned credits is declared the winner and receives an award. For example, a paytable includes three winning combinations: triple oranges, triple lemons, and triple sevens. A first player arranges the paytable from top to bottom to have the triple oranges, the triple lemons, and the triple sevens. A second player arranges the paytable from top to bottom to have the triple sevens, the triple lemons, and the triple oranges. The RNG provides ten spins in which the triple oranges hit five times, the triple lemons hit three times, and the triple sevens hit one time. The first player is the winner. Although both players earned the same amount of credits based on the triple lemons combination, which was ranked second by both players, the first player has had the selected top combination (of triple oranges) hit more than the second player's top combination (of triple sevens). Wherein the triple oranges combination hit five times, the triple sevens combination only hit once. Thus, the first player is the winner at least in part because its top combination, the triple oranges, have hit the most times.

Alternatively, the players initially select a combination in the paytable that is most likely not to hit. For example, a player selects the triple oranges combination as the most likely not to hit combination. If the triple oranges combination does hit, the player is penalized. Optionally, the player is penalized a number of credits for each time the triple oranges combination hits. The player with most credits at the end of the tournament, i.e., the player who selected the combination that hit the least number of times, is declared the winner.

Optionally, the award for the winner of the tournament can be funded by the credit balances of the losing players. For example, at the end of the tournament the leftover credits for each losing player is transferred to the winning player. Shifting player balances can be used in addition to or instead of funding the tournament prize using other means, such as using a percentage of the buy-in fee.

### Risk and Reward

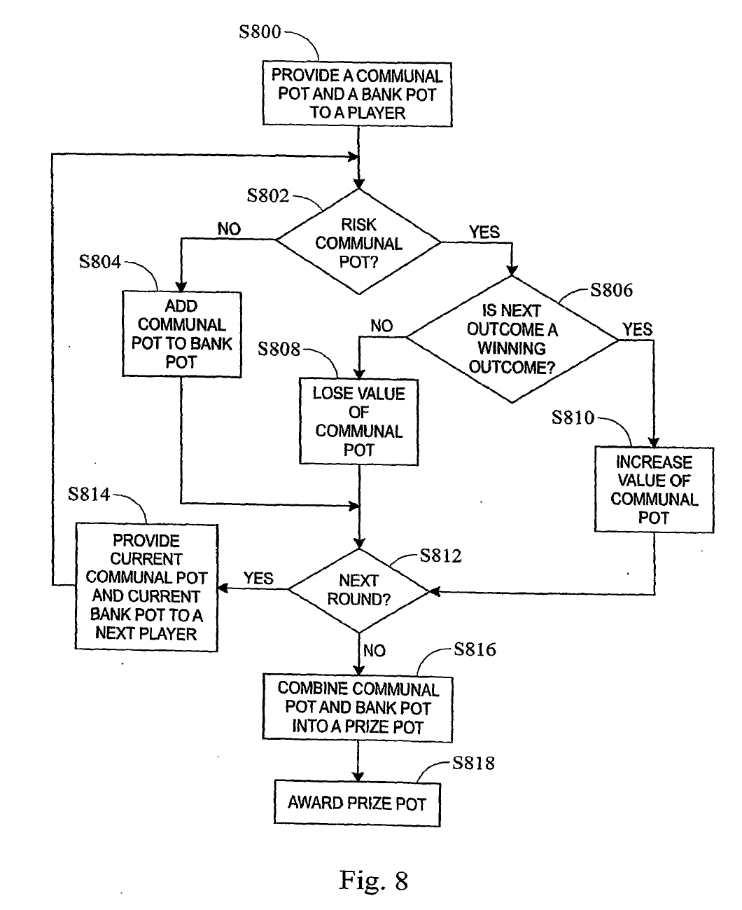

Referring to FIG. 8, a flowchart represents a risk and reward tournament that is based on what a player is banking. A group of players enter the risk and reward tournament. At step S800, a communal pot and a bank pot are provided to a player of the group of players. If the player is a first player, the communal pot and the bank pot may have standard credit amounts, or may start at zero.

The communal pot is an amount of credits that the player can risk or bank. If the player risks the communal pot and a winning outcome is selected, the communal pot is increased. If the player risks the communal pot and a winning outcome is not selected, the communal pot is lost. If the player does not risk the communal pot, wherein the player banks the communal pot, the communal pot is reset to zero and the bank pot is increased by an amount equal to the amount of the communal pot that has been banked. The bank pot is an amount of credits that cannot be risked and that has been accumulated by the group of players throughout the tournament.

At step S802, the player makes a decision whether to risk the communal pot. If the communal pot is not risked, at step S804 the credit value of the communal pot is added to the bank pot. If the communal pot is risked, at step S806 a determination is made whether the next outcome is a winning outcome. If the next outcome is not a winning outcome, at step S808 the value of the communal pot is lost and the communal pot is reset to zero. If the next outcome is a winning outcome, at step S810 the value of the communal pot is increased by a provided award (e.g., an award that doubles the value of the communal pot).

At step S812, a determination is made whether the tournament includes a next round. If the tournament includes a next round, at step S814 the current communal pot and the current bank pot are provided, or carried forward, to a next player. The next player goes through the same procedure as the player, starting with step S802.

If the tournament does not include a next round, at step S816 the communal pot and the bank pot are combined into a single prize pot. At step S818, the prize pot is awarded to one or more of the group of players. For example, the prize pot is distributed uniformly among the group of players. Alternatively, in another example, the prize pot is awarded to the player that had achieved the most winning outcomes. In yet another example, the risk and reward tournament is played similar to the game The Weakest Link®, wherein the outcome is determined by answering a series of questions. Thus, according to the embodiment described above the risk and reward tournament is a team-play tournament.

In another tournament example, the game is based on the game Wheel of Fortune®. In this tournament, the amount carried forward to the next player is lost if the next outcome is a bankrupt symbol. Nevertheless, as in the previous example, the bank is safe.

The risk and reward tournament provides at least one element of strategy because each player makes a determination whether to bank or to carry forward the communal pot. For example, if the tournament is near the end and the group of players have accumulated a large bank pot, it is less likely that the players will risk the communal pot. Thus, most likely, the players will bank any amount that is in the communal pot.

In another example of the risk and reward tournament, the tournament is an individual player game. For example, each player enters a slot-based tournament and receives twenty spins. Each player has an individual risk pot and an individual bank pot. After each spin, each player decides whether to bank or not to bank a corresponding individual risk pot. At the end of the twenty spins, the winner is determined based on which player has the largest individual bank pot. Optionally, each individual bank pot is displayed to each player. Thus, players that have small individual bank pots are more likely to gamble more towards the end of the game, while players that have larger individual bank pots are more likely to be more conservative toward the end of the game. Possibly, rank positions may change during the last few spins, creating a frenzy of excitement among the players.

In general tournaments, players are required to maximize their wagers, wherein the player would be required to wager all the purchased credits at once. However, according to an alternative embodiment of the present invention, a player decides when and how many credits the player wishes to wager. Thus, the player is provided with play-selectable wagers, wherein the player decides on a play-by-play basis how much to wager. For example, a player entry fee of $20 purchases 2,000 credits, which can be spent as the player wishes. The player can wager low at the beginning of the tournament, risking less, and wagering high at the end of the tournament. For example, the player may want to initially risk very little to get a feel for how other players are playing. If some of the other players are successful at the beginning of the tournament, the player may increase his or her wagers. In fact, the player can risk all 2,000 credits on one play, e.g., one slots spin. Although the risk is high, the player may be convinced that the likelihood of a winning outcome is also high. However, if none of the players is successful, the player might wager more conservatively.

Optionally, a bank pot may be passed from one game to another. For example, the tournament may include playing at least one game of The Weakest Link®d game and one game of the Wheel of Fortune® game. At the end of The Weakest Link® game, the bank pot is passed to the Wheel of Fortune® game. The prize pot is awarded after the players have finished playing both games and if the players have accumulated any money.

### Multi-Game

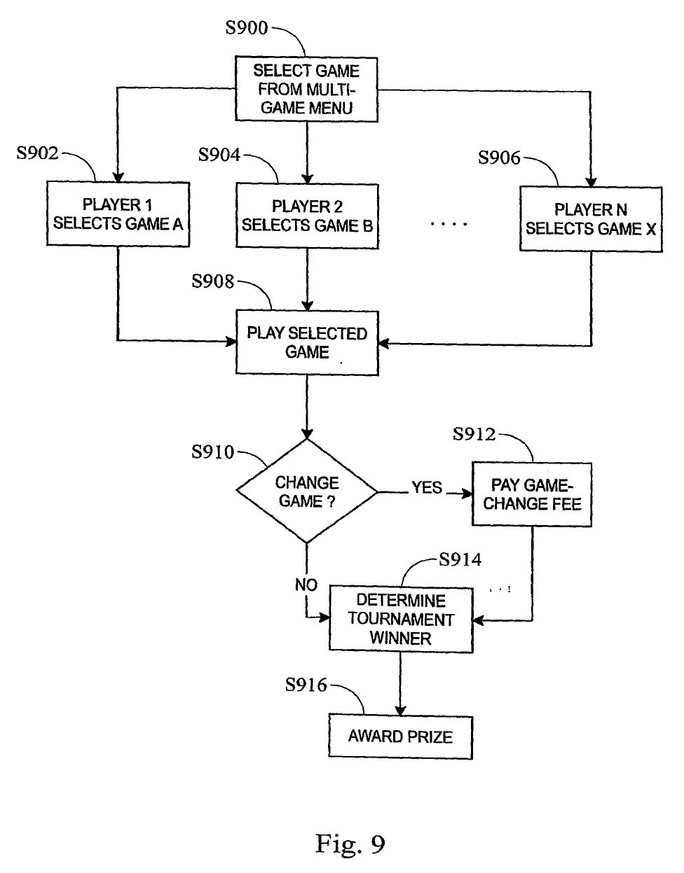

Referring to FIG. 9, a flowchart represents a multi-game tournament that includes several games that have different volatility but the same payback percentage. The players can select their own theme and/or game during the tournament. For example, a first game can have higher average awards but with a low hit frequency and a second game can have a lower average awards with a high hit frequency. Thus, each player makes a strategic decision as whether to play for high-value low-frequency hits or for low-value high-frequency hits.

In step S900, each player selects a game from a multi-game menu. At step S902, Player 1 selects Game A, at step S904, Player 2 selects Game B, and at step S906, Player N selects Game X. At step S908, each player plays the selected game. Optionally, at step S910 each player can change the originally selected game. For example, after playing about half of the tournament Player 1 notices that Player 2 has a 1,000 credit advantage. Player 1 decides that he or she must switch over to Game B because, in Player 1's opinion, Game B is a more rewarding game. Similarly, Player 2 may determine that Game A is a more conservative game. Because Player 2 is leading by 1,000 credits, he or she decides to change to Game A so that the 1,000 credits lead is conserved. If the player decides to change the game, at step S912 the player is optionally charged a game-change fee. If the player does not change the game, at step S914 the tournament winner is determined. At step S916, a prize is awarded.

Optionally, the games can dynamically change during the tournament with or without a game-change fee. For example, after a number of spins or after a period of time, Player 1 is automatically changed to play Game B, Player 2 is automatically changed to play Game X, and Player N is automatically changed to play Game A. In a further example, the players must play each game “round-robin” style, where each player must play each game at least once. The player that accumulates the most credits after playing each game is declared the tournament winner.

In another example, the volatility of the games is changed over the course of the tournament. To create excitement, the volatility of the games may be increased during the second half of the tournament. Thus, a player that has scored poorly during the first half of the tournament is provided with an opportunity to win in the second half of the tournament.

### Elimination

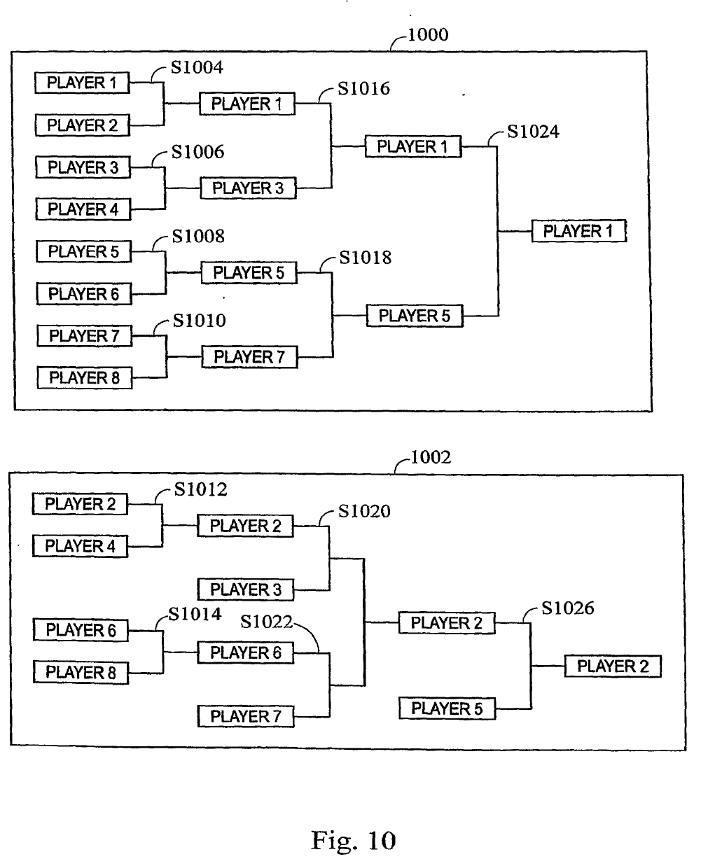

Referring to FIG. 10, a body diagram represents an elimination tournament. The elimination tournament can be based on various criteria. For example, the elimination tournament can be based on player streaks, can be pure (or single) elimination, can be double elimination, etc.

In a double elimination tournament example, the players are divided eventually into two brackets, a winning bracket 1000 and a loser bracket 1002. Players 1-8 begin play in the winning bracket 1000 and play against each other. At step S1004, Player 1 plays against Player 2, at step S1006, Player 3 plays against Player 4, at step S1008, Player 5 plays against Player 6, and at step S1010b, Player 7 plays against Player 8. Players 1, 3, 6, and 7 win their respective games.

Players 2, 4, 6, and 8 lose their respective games and, consequently, are sent to the loser bracket 1002. Player 2 plays against Player 4, at step S1012, and Player 6 plays against Player 8, at step S1014. Player 2 wins against Player 4 and Player 6 wins against Player 8.

Player 1 plays against Player 3 at step S1016 and Player 5 plays against Player 7 at step S1018. Players 1 and 5 are the winners of their respective games, advancing to the next round, while Players 3 and 7 are sent to the loser bracket 1002.

In the loser bracket 1002, Player 3 plays against Player 2, at step S1020, and Player 7 plays against Player 6, at step S1022. Player 3 and Player 7 lose their respective games and are eliminated from the tournament because this is their respective second elimination (i.e., double elimination).

Player 1 wins the game against Player 5 at step S1024 and is the winner of the tournament. Player 2 wins in a game against Player 5 at step S1026 and is the winner of the loser bracket 1002. Player 2 is awarded a consolation prize for winning the loser bracket 1002.

The elimination tournament can use a hierarchy of prize awards. For example, a first place winner will receive a large award, a second place winner will receive medium award, and a third place winner will receive a small award.

In another example, the elimination tournament is a step down tournament, which is a tournament that qualifies an eliminated player from a first tournament to participate in a second (or consolation) tournament. Thus, to reduce the negative perception of losing in a tournament, a losing player is provided with the opportunity to play in another tournament.

In yet another example, the elimination tournament includes a plurality of groups, regions, or periods. For example, a plurality of players are divided into four groups. The winners of each group play against each other to determine the winner. The group winners may play once against each other group winner, wherein the tournament winner is determined based on the highest score of each group winner. Alternatively, each of the four group winners plays a randomly selected group winner and the two undefeated group winners play each other to determine the tournament winner.

In yet another example, the elimination tournament includes having some of the tournament players branched-off to other tournaments based on player ranking. For example, players that win a first tournament are branched-off to a first tier tournament, players that ranked second in the first tournament are branched-off to a second tier tournament, etc. Optionally, the credit balance for each player is reset each time the player is branched-off to another tournament. Thus, regardless of whether a player is branched-off to another tournament with 20 credits and another player is branched-off with 20,000 credits, each player receives a fresh start.

The elimination tournament may be based on time or may be based on points. For example, a time-based tournament will end when a predetermined period of time expires. The winner is the person with the most accumulated points at the time that the period of time expires. A points-based tournament will end when a player achieves a predetermined number of points.

In an alternative embodiment, the elimination tournament is related to a card games (e.g., a Jacks or Better poker game). The tournament begins with ten players. The player having the worst hand of cards is eliminated. The other nine people are required to buy-in for the next round, should they choose to continue playing. For example, if the ninth ranked player is trailing the eighth ranked player by a lot of points, the ninth ranked player may voluntarily discontinue playing. Accordingly, the player must assess whether he or she should continue playing or quit the tournament.

As the tournament continues, the prize pool increases. The more people that quit the game, the higher the prize pool. The payback percentages are readjusted for each round such that the lower ranked player has a much lower chance of winning than a higher ranked player. Thus, instead of resetting the balance after each round, the players are allowed to retain what they have accumulated through each round. Eventually, only one player is present in the tournament and is declared the winner of the prize pool.

In yet another alternative embodiment, the elimination tournament is related to eliminating players at regular time intervals and redistributing the balance of the eliminated players to remaining players. This type of tournament can be an automated tournament that is easy for a player to understand and play, and can provide an alternative to normal game play among multiple players to increase gaming machine use.

According to some exemplary tournaments, the players can compete in random-outcome slot tournaments or in card game tournaments. For example, a tournament is a Poker tournament (e.g., TEXAS HOLD 'EM™) that includes a series of at least five games and is being played on a local area network (LAN). Each player begins the tournament with the same amount of credits/cash on the gaming machine. When a player's credits reaches zero, i.e., the player is eliminated, the remaining players each received an equal share of what the eliminated player has just lost. For example, if initially the tournament included five players, the remaining four players each receives a fourth of the eliminated player's credits. The players continue playing until only one player remains and is declared the winner of the tournament. The winning player receives the credits of all the eliminated players.

Alternatively, other criteria can be used to determined elimination of a player. For example, a player may be eliminated based on a time limit, e.g., the player with the lowest remaining credits is eliminated every ten minutes. According to alternative embodiments, the tournament can be played using spinning reel games. An optional sign can indicate the progress of the tournament and the credit/cash movement between the players. For example, two game banks are located back to back having one large sign to indicate tournament information. The tournament is optionally selected from a game screen with a fee taken from the player's wager.

### Automated/Manual Variable Game-Play

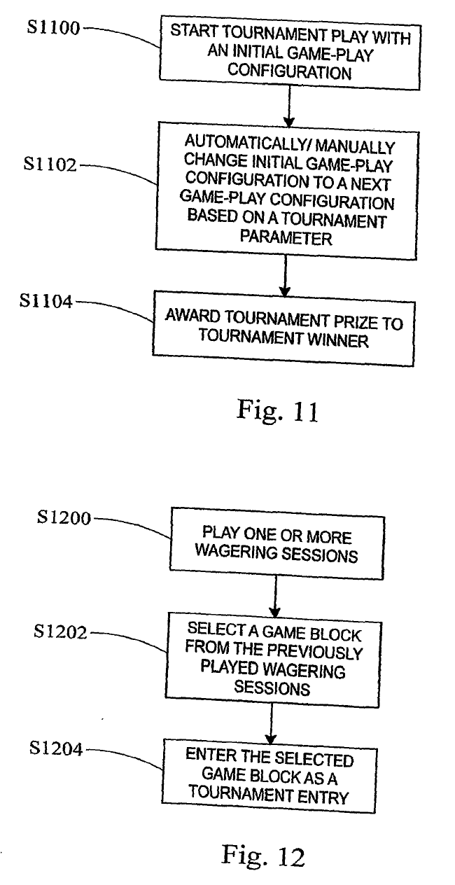

Referring to FIG. 11, a body diagram represents a tournament in which the game-play is varied automatically and/or manually. At step S1100, tournament play begins with an initial game-play configuration. At step S1102, the initial game-play configuration is automatically and/or manually changed to a next game-play configuration, which is based on a tournament parameter. At step S1104, a tournament prize is awarded to a tournament winner.

During the tournament, the players may be provided with one or more of game-enhancement parameters that can change the configuration of the game-play for the individual player and/or for all the players. For example, the game-enhancement parameters include changing paylines into scatter pays, varying the number of wild symbols, varying symbol upgrades, using nudges, using lifelines, asking-a-friend, etc. The game-enhancement parameters are discussed below in more detail.

Optionally, the players may use one or more of the game-enhancement parameters only once during the tournament. Thus, the players will use an element of strategy to decide when it would be best to change the tournament game-play. For example, if the player is in the process of losing, the player may want to increase the number of paylines to provide an opportunity to receive a high score within a short period of time. In another example, the number of paylines is increased or decreased based on time. For example, the tournament begins with one payline and after each minute another payline is added to the initial game-play configuration. The tournament ends after twenty minutes, wherein the final game-play configuration includes twenty paylines. Optionally, a payline may be awarded to a player if the player meets a predetermined requirement, such as the player achieving a predetermined level.

In an alternative embodiment of the present invention, a tournament rewards or encourages the biggest loser. When a player runs out of credits during the tournament, and the tournament has not ended, the player's balance is reset to a predetermined credit balance. For example, after a player has lost all the initially-provided credits, the player's balance is reset and the paytable is juiced-up (which means that the winning combinations pay more than the standard paytable). The juiced-up paytable, which pays higher awards for winning combinations, provides the losing player with the opportunity to advance in the tournament ranking.

Optionally, the credit balance of a player that has lost all the initially-provided credits is reset to twice the initial value. Thus, it is possible that a player that loses all of the initially-provided credits ten times faster than normal, may end up with the most money because he or she continuously increases the initial balance. One strategy of winning the tournament is to be able to have a reset initial balance, as high as possible, when the tournament is over. For example, a time-based tournament has a one minute limit. Each player beings with 1,000 credits and, upon reaching a zero balance, the balance is reset to 2,000 credits. Instead of focusing on winning credits (i.e., adding credits to the 1,000 initial credit balance), a player may focus on wasting the entire initial credit balance so that he or she receives 2,000 credits. Thus, it is possible that a person that loses better may win the tournament, whereas a person that focuses on winning credits may actually end up losing.

In an alternative embodiment, each player is provided with a skill-stop, or auto-play, feature. The auto-play feature reduces the need for player input during the tournament. For example, the auto-play feature reduces the need for a player to continuously bang on a play button to play as fast as possible. In one embodiment, the auto-play feature automatically repeats the player's previous selection if the player does not act with a set period of time. Alternatively, the player provides one or more instructions to set-up the auto-play feature, and, subsequently, the auto-play feature makes the appropriate selections during the tournament.

The variable game-play tournament includes various game-enhancement parameters to provide the player with additional excitement during play. For example, the game-enhancement parameters include: “RANDOM MULTIPLIER,” “AUTOMATIC NUDGE,” “UPGRADE,” “DIFFERENT PAY TABLE,” “EXTRA WILD,” “SCATTER,” “RIGHT-TO-LEFT,” “RE-SPIN,” “MORPH,” “INCREASED WAGER,” “HOLD SYMBOL,” and “SYMBOL MOVEMENT.” Different types of game-enhancement parameters provide the player with the opportunity to achieve a higher payout or make it easier for the player to achieve a payout or other award. The game-enhancement parameters discussed below may be randomly assigned during the tournament or may be provided to be used at the player's discretion.

The RANDOM MULTIPLIER game-enhancement parameter multiplies a payout or other outcome awarded to the player. The RANDOM MULTIPLIER game-enhancement parameter may take the form of an electronic pair of dice or a single die spinning on a gaming machine display. While the die/dice spins, an internal light on the gaming machine 10 flashes to indicate potential multipliers available to the player (e.g., 1×-6×). Once the die/dice stops spinning, the player is awarded a multiplier equal to the number displayed on the die/dice. In other embodiments, the player is awarded, e.g., a 1× multiplier when the die/dice stops on an odd number, and a 2× multiplier when the die/dice stops on an even number. Once the reels stop spinning, the winning result is multiplied by the multiplier. In other embodiments, the value of the RANDOM MULTIPLIER game-enhancement parameter may be determined by any other pseudo-random process.

The AUTOMATIC NUDGE game-enhancement parameter is advantageous in situations where a better payout can be achieved by moving symbols on one (or multiple) reels either up or down across a payline. This game-enhancement parameter automatically “nudges” the reels to the better symbol combination to achieve a higher payout. For example, in the event that three reels display a combination of “3-bars,” “3-bars,” and “1-bar” symbols on an active payline, and a “3-bars” symbol is located directly above the “I-bar” symbol on the third reel, the symbols on the third reel would be nudged downward so that three “3-bars” symbols are displayed on the payline, resulting in a higher payout.

The UPGRADE game-enhancement parameter causes a winning symbol combination to move up at least one or two winning symbol combinations on the pay table for the gaming machine 10. For example, a lower-paying combination of three “cherry” symbols may pay out as if the player had achieved three “3-bars” symbols, a better combination.

The DIFFERENT PAY TABLE game-enhancement parameter implements a different and higher-paying pay table, awarding larger payouts for various symbol combinations. For example, if a combination of three “cherry” symbols normally pays out 200% of the original wager, the DIFFERENT PAY TABLE game-enhancement parameter may result in a payout of 300% of the original wager for the combination.

The EXTRA WILD game-enhancement parameter causes a symbol that is normally a regular symbol, such as a “cherry” symbol or a “1-bar” symbol, to become a wild symbol. For example, in the event that (a) the player achieves a combination of consecutive “3-bars,” “3-bars,” and “1-bar” symbols, and (b) and the EXTRA WILD game-enhancement parameter causes all “1-bar” symbols to become wild symbols, then (c) the wild “1-bar” symbol would represent a “3-bars” symbol, and the player would be awarded a payout for achieving a combination of three “3-bars” symbols. This combination would provide a larger payout than the initial combination.

The SCATTER game-enhancement parameter converts a single-line pay into a scatter payout, such that a winning combination of symbols need not be located all on a single active payline. As such, the best possible symbol combination on the display results in the award to the player.

Many slot games require that winning combinations be comprised of symbols on consecutive reels, and must start with the left-most reel (i.e., these slot games require a “left-to-right” combination of symbols). The RIGHT-TO-LEFT game-enhancement parameter allows “right-to-left” combinations (i.e., combinations starting on the right-most reel and extending left across the reels) to win, in addition to the standard winning “left-to-right” combinations. This game-enhancement parameter is particularly relevant to a slot game having five (or more) reels. For example, if the five symbols on the payline from the left-most reel are “cherry,” “1-bar,” “1-bar,” “1-bar,” and “1-bar,” the player would not have achieved a winning combination of a machine paying left-to-right only. However, if the RIGHT-TO-LEFT game-enhancement parameter were implemented, then the player would have a winning combination of symbols (i.e., the four “I-bar” symbols from the right side).

This game-enhancement parameter can also enhance the player's payout in additional ways. For example, if the player had achieved three consecutive “cherry” symbols from the left side on a first active payline, and the same four consecutive “1-bar” symbols as discussed above from the right side on a second active payline, the RIGHT-TO-LEFT game-enhancement parameter would result in the player being awarded payouts for winning combinations on both the first and the second active paylines.

In another example, the player may also achieve two winning payouts on the same active payline. For example, if the player had achieved a combination of five consecutive “cherry” symbols on the five reels, the player would be awarded a payout based on both the right-to-left and the left-to-right winning combinations. Also, in the event that only two consecutive symbols are required for a winning combination, the player could achieve two different winning symbol combinations on the same active payline. For example, if the player had achieved “cherry,” “cherry,” “3-bars,” “1-bar,” and “1-bar” symbols on the reels, the player would receive a payout for both (a) the left-to-right winning combination of “cherry” symbols, and (b) the right-to-left winning combination of “1-bar” symbols.

In the event that the player does not achieve a high-paying winning combination, the RE-SPIN game-enhancement parameter re-spins one or more of the reels, giving the player an additional chance to get a high-paying winning combination. For example, if the player achieves a winning combination of three “cherry” symbols, then the player would be awarded for the win and then the reels would be re-spun, giving the player a chance at an additional payout. In other embodiments, the player has to give up the payout from an initial winning combination in order to implement the RE-SPIN game-enhancement parameter.

The MORPH game-enhancement parameter allows one or more symbols on the reels to morph into other symbols that are more beneficial. For example, if the player gets a combination of two “cherry” symbols and a “1-bar” symbol, and (a) the two “cherry” symbols combination has a certain winning outcome, and (b) a combination of three “cherry” symbols would result in a higher winning combination, then the “1-bar” symbol morphs into a “cherry” symbol, resulting in the higher-paying winning combination.

A winning combination typically results in a payout that is generally proportionate to the amount wagered. For example, when five credits are wagered and the player achieves a winning combination, the payout is at least five times as large as it would have been if only one credit had been wagered. The INCREASED WAGER game-enhancement parameter treats a winning combination as though the player had bet the maximum amount, thereby effectively increasing the wagered amount, resulting in a higher payout. For example, of the player had only wagered 1 of 5 possible credits, the INCREASED WAGER game-enhancement parameter would treat the player's wager as though 5 credits had been wagered.

The HOLD SYMBOL game-enhancement parameter holds a symbol in a certain location on one of the reels so that a final symbol combination across the reels must take into account the held symbol. For example, in the event that a “I-bar” symbol is one of the more valuable symbols available, a reel displaying this symbol may be held (e.g., not spun) while the remainder of the reels spin. The symbol on the reel that is held may be selected by the player from a list of different hidden symbols, or may be randomly assigned to the player. Accordingly, when the other reels are spun, the player has a greater chance of receiving a high payout (e.g., by a winning combination including the valuable held symbol).

The SYMBOL MOVEMENT game-enhancement parameter allows symbols to move to others location along a payline if it would result in a better outcome (e.g., a higher payout). For example, symbols can move up or down on the same reel, or they can move across reels if such movement results in a better combination for the player.

The game-enhancement parameters discussed above are merely examples, and it should be appreciated that this list is not exhaustive. In practice, additional types of game-enhancement parameters may be employed.

### Retroactive Tournament

Referring to FIG. 12, a body diagram represents a retroactive tournament in which a player retroactively selects a game block as a tournament entry block. The game block is selected from previously saved game blocks, which can include any block that the player has played over the course of previously or currently played tournaments. For example, the player can restore one or more game blocks similarly to restoring game assets (via the information reader 52) that the player has achieved and saved during a previous game session The previously or currently played tournaments can be played over multiple gaming sessions, e.g., over the course of several hours, days, weeks, etc.

In some tournaments, the players are permitted to play at least portions of the tournament at any time within a fixed period of time. For example, the players are required to play fifty tournament slots spins anytime within a particular week. Thus, while each player must play fifty tournament slots spins, each player can play the fifty tournament slots spins as their own schedule permits. In some instances, players purchase normal slots spins that are not necessarily tournament-dedicated spins. One problem with normal slots spins is that the player may lose an opportunity to enter a high-ranking slots spin in the tournament. The retroactive tournament eliminates this problem because the player can enter any of the played spins as the tournament spins.

At step S1200, the player plays one or more wagering sessions. For example, the player plays a wagering session on day one of a two-day fifty-spin tournament, wherein the player plays fifty spins. The player plays another wagering session on day two of the tournament, wherein the player plays another fifty spins.

At step S1202, the player selects a game block from the previously played wagering sessions to enter as his or her tournament entry. For example, the player can select any fifty spins from the one hundred spins played during day one and day two of the tournament (fifty spins on day one+fifty spins on day two). The player will most likely select the top fifty spins from the played spins. Optionally, the top fifty spins are automatically selected for the player.

At step S1204, the selected game block of fifty spins are entered as the player's tournament entry. Accordingly, it is assumed that the player is able to enter as his or her tournament entry the best performance that he or she was able to perform. Each tournament entry is compared and a tournament winner is determined.

Another advantage of the retroactive tournament is that it removes the possibility that the player may perform well during normal spins and bad during the tournament. The player's best performance during the tournament time period is selected and entered for tournament purposes.

Optionally, instead of having a time limit, the retroactive tournament allows each player a fixed number of selections. After the selections are made, the player is permitted to select one or more of a limited number of selections as that player's top selections. For example, each player is permitted to make ten selections in a Monopoly® game. After the players have made the selections, each player is permitted to retain only the top three selections. Thus, if a player has landed on ten different properties, the player will retain only the three properties that are most likely to make the player the winner.

The features described above in reference to FIGS. 3-12 may be incorporated in any of the described tournaments. Further, as described below, other optional and/or alternative embodiments may be incorporated in any of the described tournaments.

For example, a progressive tournament can be played upon receiving an invitation. The tournament is funded at least in part by a progressive jackpot. Optionally, a portion of the tournament prize may be funded at least in part by a buy-in fee. The invitation may be sent to predetermined gaming machines, may be randomly generated, and/or may be a mystery invitation. A mystery invitation “surprises” a player in the midst of the player playing a regular game. The player can accept or reject the “surprise” invitation. For example, the mystery invitation may be sent to a player that meets predetermined eligibility requirements, such as the player meeting a play frequency requirement. One reason for sending a mystery invitation is to reward a player that has a high frequency play rate.

In another example, a tournament can be triggered by a player meeting a predetermined requirement. For example, if a player hits a high score, the tournament is triggered. Optionally, all the players except the triggering player must buy-in to play in the tournament. However, as a reward, the triggering player enters the tournament without paying the buy-in fee.

In yet another example, a tournament can start when a required number of players has been achieved. For example, a first player pays a 25 credit buy-in fee for a tournament that requires ten players. While waiting for the other nine players to join the tournament, the first player waits until notified that the tournament is ready to start. While waiting, the first player can optionally play other games.

In yet another example, a tournament is based on the number of points that a player has accumulated during a set period of time. The player is rewarded for investment/loyalty in the game. For example, the tournament is played for a week. A player that plays ten hours a day for seven days is more likely to win the tournament than a player that plays one hour a day for three days.

In yet another example, a tournament compensates non-winners. For example, a tournament includes only one winner from a group of twenty players. At the end of the tournament, all the positive credit balances are redistributed among the nineteen losing players.

In yet another example, a player accumulates tournament spots, or places, while playing regular games. The spots are used to play in a tournament that is played via an RNG. The more games that the player plays, the more spots that the player may accumulate. Thus, the player is rewarded for his or her high-play activity.

In yet another example, a player can auction or sell a tournament place. In an exemplary tournament mode, the players compete for the highest score within some period of time. A player that wishes to leave the tournament before the tournament ends can auction his or her place in the tournament to the highest bidder. For example, player A has the highest score, player B has the second highest score, and player C has the lowest score. If, for any reason, player A must leave the tournament before the time period for tournament play has expired, player A will risk losing to player B. Because player B is likely to increase his or her score to a larger score than player A (given that player A will no longer participate in the tournament), player A can auction his or her tournament place to any of player B, player C, or another non-participant. Although player A will likely profit less from auctioning his or her place than from winning the tournament, player A is guaranteed to receive some profit by the auction. Optionally, instead of auctioning the tournament place, the player can sell, trade, or give away the place. Further, the tournament place is likely to have a value that generally increases as the tournament near its end. For example, a “First Place” may have a lower value towards the beginning of the tournament than towards the end-of the tournament.

While the present invention has been described with reference to one or more particular embodiments, those skilled in the art will recognize that many changes may be made thereto without departing from the spirit and scope of the present invention.

Each of these embodiments and obvious variations thereof is contemplated as falling within the spirit and scope of the claimed invention, which is set forth in the following claims.

1. A method of offering a wagering game tournament to a plurality of players on a plurality of gaming machines located on a gaming network, the method comprising:
increasing a prize pool based on a group achievement of the plurality of players; and
distributing the prize pool to at least some of the plurality of players.

2. The method of claim 1, further comprising distributing the prize pool uniformly to at least some of the plurality of players.

3. The method of claim 1, further comprising distributing the prize pool to at least some of the plurality of players based on at least one distribution criterion.

4. The method of claim 3, wherein said distribution criterion is selected from a group consisting of player-accumulated credits, player-accumulated points, player ranking, and player-associated outcome.

5. The method of claim 1, further comprising setting a time limit for playing said wagering game tournament.

6. The method of claim 1, further comprising setting an individual spin limit for each of said plurality of players, wherein the wagering game tournament is a slots tournament.

7. The method of claim 1, further comprising setting a total spin limit for the plurality of players.

8. The method of claim 1, wherein the group achievement is selected from a group consisting of accumulated credits, accumulated points, a predetermined game outcome, and a tournament terminating outcome.

9. The method of claim 1, further comprising receiving an entry fee from each of the plurality of players.

10. A computer readable storage medium encoded with instructions for directing a gaming device to perform the method of claim 1.

11. A gaming network for offering a wagering game tournament to a plurality of players on a plurality of gaming machines, each gaming machine comprising:
a display for displaying the wagering game tournament in response to receiving a wager input from a player; and
a controller coupled to the display and programmed to
allow a player of the plurality of players to participate in the wagering game tournament;
increase a prize pool based on a group achievement of the plurality of players; and
distribute the prize pool to at least some of the plurality of players.

12. The gaming network of claim 11, wherein the controller is further programmed to distribute the prize pool uniformly to at least some of the plurality of players.

13. The gaming network of claim 11, wherein the controller is further programmed to distribute the prize pool to at least some of the plurality of players based on at least one distribution criterion.

14. The gaming network of claim 13, wherein said distribution criterion is selected from a group consisting of player-accumulated credits, player-accumulated points, player ranking, and player-associated outcome.

15. The gaming network of claim 11, wherein the group achievement is selected from a group consisting of group accumulated credits, group accumulated points, a game outcome, and a tournament terminating outcome.

16. The gaming network of claim 11, wherein said controller is located within said gaming machine.

17. A method of conducting a wagering tournament on a gaming network, the method comprising:
accepting a group of players for participation in the wagering tournament, each player of the group of players playing on a corresponding gaming machine of the gaming network;
achieving a group-based tournament threshold;
increasing a tournament prize based on the achieving step; and
distributing the tournament prize to the group of players.

18. The method of claim 17, wherein the group-based tournament threshold is selected from a group consisting of accumulated points, accumulated credits, and a game outcome.

19. The method of claim 17, wherein the distributing step further comprises distributing the tournament prize based on player rank, player-accumulated points, player-accumulated credits, and player-associated outcome.

20. The method of claim 17, further comprising setting a time limit for achieving the group-based tournament threshold.

21-25. (canceled)

26. A method of offering a wagering game tournament to a plurality of players on a plurality of gaming machines located on a gaming network, the method comprising increasing a prize pool based on at least one of the plurality of players achieving a tournament milestone.

27. A method of offering a wagering game tournament to a plurality of players on a plurality of gaming machines located on a gaming network, the method comprising:
receiving a side wager from a first player of the plurality of players for wagering on a second player of the plurality of players; and
awarding an award to the first player if the second player is a tournament winner.

28-29. (canceled)
